(19) United States
(12) Patent Application Publication
(10) Pub. No.: US 2009/0228374 A1
(43) Pub. Date: Sep. 10, 2009

(54) System and method for optimizing delivery of inventoried content to mobile networks

(76) Inventors: Venkatesh Karnam, Sunnyvale, CA (US); Donald Flood, San Francisco, CA (US); Mark Schaaf, San Francisco, CA (US)

Correspondence Address: CARR & FERRELL LLP, 2200 GENG ROAD, PALO ALTO, CA, 94303, US

(21) Appl. No.: 12/075,130

(22) Filed: Mar. 6, 2008

(51) Int. Cl. G06Q 10/00

(52) U.S. Cl. 705/28

(57) ABSTRACT

The present invention provides a system and method for optimized delivery of inventoried content to mobile networks. According to one embodiment, a remote inventoried content server is installed in the geographic locale of a publisher of content for users of mobile communications devices on a mobile network. The remote inventoried content server is remote from the residence of an inventoried content delivery service. The remote inventoried content server maintains and updates its inventoried content through periodic communication with the inventoried content delivery service, so that the remote inventoried content server can supply its local publishers with fresh inventoried content in the short times required but as yet unachievable for display through a mobile network. The remote inventoried content server may also incorporate some of the logic of the inventoried content delivery service, further increasing the efficiency of delivering inventoried content to a mobile network.

### BACKGROUND OF THE INVENTION

1. Field of the Invention

This invention relates to mobile networks, and particularly to the movement of inventoried context through a mobile network.

2. Description of Related Art

One type of mobile network is a network connecting pocket-sized communication devices, such as hand-held cellular or mobile telephones, PDAs, or other devices that fit easily in a user's pocket.

“Inventoried content” is information the delivery of which is accounted for, such as electronic advertisements delivered to a user of a mobile device. Charges for such an advertisement may be based, for example, on the number of times the ad is displayed on or sent to one or more devices, and/or on the number of user interactions with the ad display, such as a click on a displayed ad by a user. Thus, an accounting system may monitor ad displays, transmissions, clicks on ad displays, etc.

Services that deliver inventoried content to users of devices in a mobile network currently face many limitations arising from the nature of the mobile network and of the devices used with the mobile network. For example, communication over a mobile network is typically wireless, depending on signals sent from a source to a user device through one or more relay towers. Thus, such communication is slow compared to communication occurring between computers over the internet, for example. Pageloads are very slow over a mobile network, while they are so fast over the internet that they are no longer considered a bottleneck in that technology. Also, the screens of devices used with a mobile network, such as mobile telephones, are very small compared with laptop or desktop personal computer screens, so that very little information can be displayed usefully on the screen of the mobile device. Accordingly, activities like search-driven internet web browsing, which is efficient on laptop computers, are cumbersome at best for a user of a mobile phone on a mobile network.

One common approach to delivering inventoried content over a mobile network is for a publisher of content for mobile devices to request inventoried content from an inventoried content delivery service, such as a company that sells advertisements. For example, if a publisher of displays for mobile devices, such as ESPN Mobile Web, wants an ad to appear when its site on a mobile network is loaded on a mobile device, it may include in the code for its display a request for an ad from an inventoried content delivery service. If the user of the mobile phone who opens the ESPN Mobile Web display is in Russia and the inventoried content delivery service is in Canada, there may be an unacceptably long latency period while the publication request originating in Russia reaches Canada, and the inventoried content sent from Canada reaches the user in Russia. Exemplary latency periods currently experienced are 280 milliseconds each way from Russia to California, USA, and 220 milliseconds each way between California and Turkey. Also, the local cache may be overloaded as delays interfere with the flow of information between the user and the inventoried content delivery service over the mobile network.

Thus, currently available protocols for providing inventoried content are still too slow for use on mobile networks, especially when users of devices on a mobile network are geographically distant from inventoried content delivery services. There is not an efficient way to deliver inventoried content to mobile devices on mobile networks, reducing the latency periods and cache overloads described above.

### SUMMARY OF THE INVENTION

The present invention provides a system and method for optimized delivery of inventoried content to mobile networks. According to one embodiment, a remote inventoried content server is installed in the geographic locale of a publisher of content for users of mobile communications devices on a mobile network. The remote inventoried content server is in a remote location from that of an inventoried content delivery service. The remote inventoried content server maintains and updates its inventoried content through periodic communication with the inventoried content delivery service, so that the remote inventoried content server can supply its local publishers with fresh inventoried content in a short time required for display through the mobile network. The remote inventoried content server may also incorporate some of the logic of the inventoried content delivery service, further optimizing the efficiency of delivering inventoried content to a mobile network.

### BRIEF DESCRIPTION OF THE DRAWINGS

FIG. 1 is a block diagram showing an environment for efficiency-optimizing delivery of inventoried content to mobile networks in which the present invention may be used.

FIG. 2 is a block diagram of an exemplary architecture for optimizing delivery of inventoried content to mobile networks according to the present invention.

### DETAILED DESCRIPTION OF THE INVENTION

The present invention provides a system and method for more efficient delivery of inventoried content to mobile networks than is available in the prior art. An inventoried content delivery service exports some of its logic and inventoried content to one or more remote inventoried content servers, rather than having all of its logic and inventoried content reside only on servers local to its place of business, updating the content periodically (and optionally over land lines) if desired. Thus, when a user of a mobile device on a mobile network attempts to load a display calling for inventoried content, the request need not be routed to the inventoried content delivery service, which may be distant, but can be addressed by a remote inventoried content server that is remote from the service but local to the user of the mobile network.

For example, when a user of a mobile phone opens a display by the publisher ESPN Mobile Web in Russia, the request for inventoried content embedded in the code for the display need travel only to a remote inventoried content server in France, for instance, even though the inventoried content delivery service is in Canada. Thus, the latency period for the inventoried content to reach the user is shorter than it would be if the request had to travel to, and the response from, Canada. The latency period will be shorter still if a remote inventoried content server is available in Moscow. The remote inventoried content server may be remote from the inventoried content delivery service, but local to users anywhere in the world.

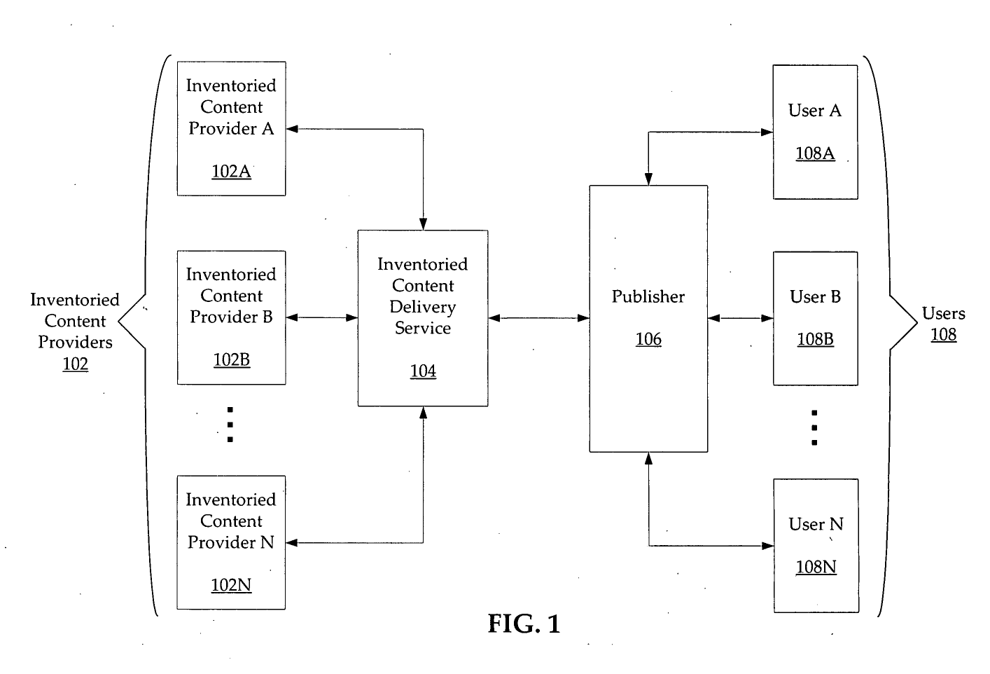

FIG. 1 is a block diagram showing an environment for efficiency-optimizing delivery of inventoried content to mobile networks in which the present invention may be used. This environment comprises one or more inventoried content providers 102, an inventoried content delivery service 104, one or more publishers 106, and one or more users 108. Inventoried content providers 102, such as providers 102A, 102B, and 102N, communicate with an inventoried content delivery service 104. The inventoried content providers 102A-102N may be any kind of inventoried content providers, such as a company providing advertisements and/or installments of an electronic periodical. Any kinds of inventoried content providers 102 fall within the scope of various embodiments.

The inventoried content delivery service 104 may similarly be any business or entity that delivers inventoried content, such as advertisements. For example, the inventoried content delivery service 104 may provide a service that allows one or more inventoried content providers 102 to design and identify advertisements for display to users 108 of devices on a mobile network. In some embodiments, the inventoried content delivery service 104 accepts inventoried content from one or more inventoried content providers 102, tracks statistics related to the display of the inventoried content to one or more users 108, and reports data to and/or bills an inventoried content provider 102 according to the statistical information gathered. In other embodiments, the inventoried content delivery service 104 may bill the inventoried content provider 102 according to competing bids placed by the inventoried content providers 102.

The inventoried content delivery service 104 also communicates with one or more publishers 106. A publisher 106 comprises any business or entity that publishes displays on a mobile device of a user 108 of a mobile network. For example, ESPN Mobile Web is a publisher 106 that prepares code for and sends displays to users 108. As described above, the publisher's code for the display may include code that requests inventoried content, such as an ad, from the inventoried content delivery service 104. In an exemplary embodiment, the inventoried content delivery service 104 monitors the number of times an ad is incorporated into the display provided by a publisher 106 to a user 108 (called an “impression”), and reports statistics on the impressions to the publisher 106 and or to the inventoried content provider 102. The inventoried content delivery service 104 may also calculate revenue due from the inventoried content provider 102 to the publisher 106 based on the statistics.

A company like Starbucks, Inc., may become an inventoried content provider 102 by providing an ad to an inventoried content delivery service 104. A publisher 106, such as ESPN Mobile Web, may include in the code for its display a request for inventoried content to be provided by the inventoried content delivery service 104. A user 108 of a mobile phone may access an ESPN Mobile Web display of sports information, such as the score of a recent game. If the inventoried content sent from inventoried content delivery service 104 to the publisher 106 includes the ad designed by Starbuck's, then a Starbuck's ad also appears on the display that reports the score to the user 108 on his mobile phone. Any interactions of the user 108 with the ad through his mobile phone may optionally be tracked by the inventoried content delivery service 104. Users 108A-108N may use any mobile communication device, such as a cellular telephone, or a personal digital assistant.

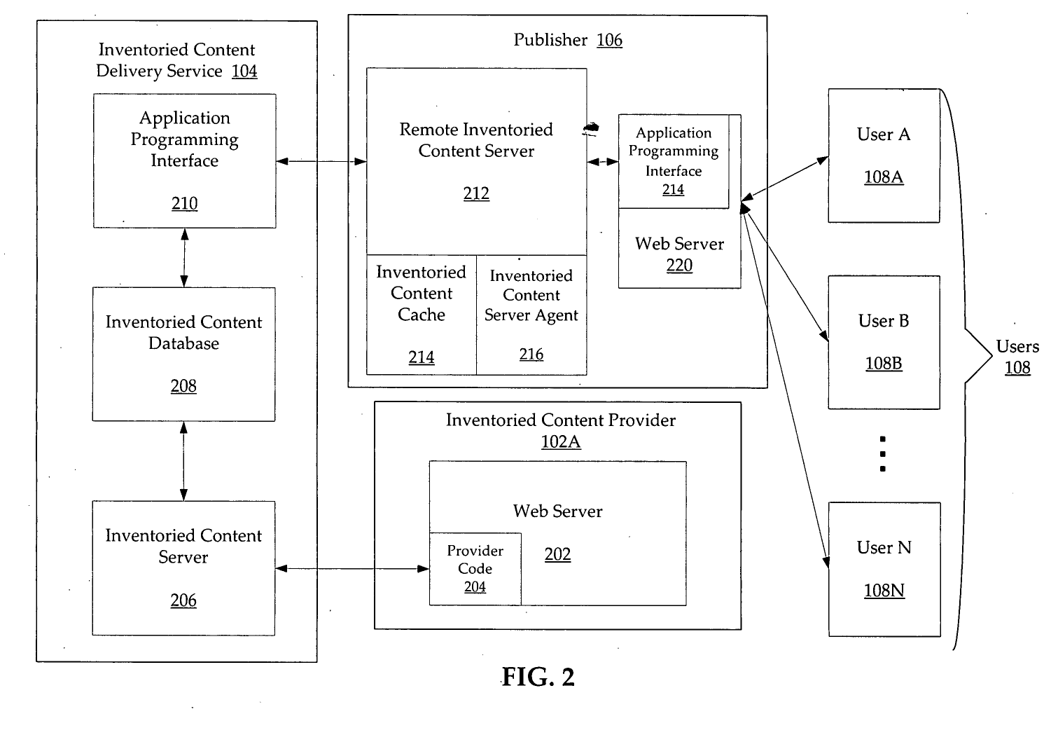

FIG. 2 is a block diagram of an exemplary architecture for optimizing delivery of inventoried content to mobile networks according to the present invention. FIG. 2 shows an exemplary inventoried content provider 102A, an inventoried content delivery service 104, and a publisher 106. The inventoried content provider 102A comprises a web server 202 that may provide inventoried content to an inventoried content delivery service 104 according to some provider code 204. An example of an inventoried content provider 102A is an entity that produces an advertisement, such as Starbuck's in the example above.

The inventoried content delivery service 104 comprises an inventoried content server 206, an inventoried content database 208, and an application programming interface 210. The inventoried content server 206 may communicate with one or more inventoried content providers 102 and receive inventoried content from them. Received inventoried content may be stored in an inventoried content database 208. When the inventoried content delivery service 104 provides inventoried content to a publisher 106, it may do so by communicating with the publisher via an application programming interface 210.

The publisher 106 comprises a remote inventoried content server 212, which may include an inventoried content cache 214 and an inventoried content server agent 216. The remote inventoried content server 212 resides in the collocation area of the publisher 106, which may be remote from the inventoried content delivery service 104. The remote inventoried content server 212 may stand alone (not shown), or may reside with another provider of content for a mobile network, such as a publisher 106.

The remote inventoried content server 212 may, for example, comprise a Java application that runs on Linux, Unix, Windows, or any language that the publisher 106 is running; Installation of the remote inventoried content server 212 may entail installation of software onto the hardware of the publisher 106, or the installation of dedicated hardware into or near the publisher's other hardware. Configuration may be simple, involving as little as providing the remote inventoried content server 212 with the publisher ID. The remote inventoried content server 212 may periodically ping the inventoried content delivery service 104, even as often as every few seconds, requesting more or fresh inventoried content. These requests may be tailored to the needs of the publisher and user according to the operation of the inventoried content server agent 216, or the inventoried content delivery service 104 may determine which inventoried content to use to update the inventoried content cache 214.

The remote inventoried content server 212 keeps an inventory of fresh inventoried content in a cache 214, which may be updated periodically through communication with the inventoried content delivery service 104, so that fresh inventoried content is always available when requested by a user 108 and/or a publisher 106. Thus, the cache 214 may be used to maintain a full advertisement inventory, for example, so that the publisher does not have idle requests for advertisements awaiting inventoried content.

The presence of the inventoried content cache 214 relieves the publisher 106 of the necessity of caching. This development is advantageous because caching by the publisher 106 demands overhead from the publisher 106, and may result in inappropriately reduced revenues to inventoried content providers 102 and/or publishers 106. For example, if an ad is loaded into the cache of the publisher 106 once, but shown to users 108 seventeen times, a calculation of advertising fees on the basis an impression of an ad that is tracked as a delivery to the publisher 106, will not capture the other sixteen impressions that were actually displayed to the users 108.

The inventoried content server agent 216 includes some of the logic and code that normally resides with the inventoried content delivery service, such as instructions for logging impressions of inventoried content displayed to users 108 and reporting statistical data to the inventoried content delivery service 104, and algorithms for calculating the optimal inventoried content to produce in response to a user or publisher request over a mobile network. In addition to the operation of the inventoried content server agent 216, the publisher 106 may determine which inventoried content to provide to the users 108, for example, by preventing advertisements that compete with a favored advertisement from being displayed to the users 108 on displays provided by the publisher 106. By including the inventoried content server agent 216 in the remote inventoried content server 212, the inventoried content delivery service 104 effectively pushes its logic closer to the locale of the publisher 106.

The location of the remote inventoried content server 212 near the publisher 106, and the frequent updating of information in the inventoried content cache 214, increase the efficiency of providing inventoried content to a mobile network by reducing the problematic latency and local cache overload discussed above. Efficiency may further increased by enabling the optimization algorithms of the remote inventoried content server 212 to work locally to choose the best inventoried content to provide to the publisher 106 and/or to the user 108.

For example, when a request for an advertisement encoded in a the display provided by a publisher 106 to a user 108A is processed by the remote inventoried content server 212, the remote inventoried content server 212 may not only immediately provide a fresh advertisement, but may also optionally run code that calculates which of the advertisements in its cache 214 would bring in the most revenue to the publisher, and respond to the request by supplying that “best” ad. Without the remote inventoried content server 212, not only would the request have to travel, for example, from the user 108 in Russia to the inventoried content delivery service 104 in Canada and the ad return over that long distance, but the calculation for which ad to send would have to be performed in Canada as well. By incorporating the logic of the inventoried content delivery service 104 in the inventoried content server agent 216, the remote inventoried content server 212 may further increase the efficiency of providing inventoried content to a mobile network.

The remote inventoried content server 212 may deliver inventoried content to the users 108 via an application programming interface 218 on a web server 220 of the publisher 106. The publisher 106 may also deliver its own inventoried content or inventoried content from additional sources other than the inventoried content delivery service 104 to the users 108 through the application programming interface 218 and the web server 220. In other words, the publisher may combine the inventoried content provided via the remote inventoried content server 212 with any other content. The inventoried content server agent 216 optionally may include inventoried content from the publisher 106 and additional sources other than the inventoried content delivery service 104 in its optimization calculations. Any kinds of application programming interfaces and servers in the exemplary architecture fall within the scope of various embodiments.

While various embodiments have been described above, it should be understood that they have been presented by way of example only, and not limitation. Thus, the breadth and scope of a preferred embodiment should not be limited by any of the above-described exemplary embodiments.

What is claimed is:

1. A method for providing inventoried content from an inventoried content delivery service to a user of a communication device on a mobile network, the method comprising:
providing an inventoried content server in a location local to a publisher of inventoried content and remote from the inventoried content delivery service;
receiving inventoried content at the server from the inventoried content delivery service;
processing the received inventoried content at the server; and
sending the received inventoried content from the server to the user across the mobile network.

2. The method of claim 1, further comprising requesting inventoried content from the inventoried content delivery service via the inventoried content server.

3. The method of claim 1, wherein the inventoried content server is configured with logic comprising a portion of the logic of the inventoried content delivery service.

4. The method of claim 1, further comprising combining the inventoried content with other content.

5. The method of claim 1, wherein the inventoried content comprises advertisements.

6. A method for providing inventoried content to a publisher in a mobile network, the method comprising:
installing a remote inventoried content delivery server in a collocation service area local to the publisher;
sending the inventoried content to the remote inventoried content delivery server;
receiving a request at the remote inventoried content delivery server for inventoried content from the publisher;
delivering the inventoried content from the remote inventoried content delivery server to a user across a mobile network.

7. The method of claim 6, further comprising providing the remote inventoried content delivery server with an update of inventoried content.

8. The method of claim 7, wherein the update occurs whenever the inventoried content is below a predetermined amount.

9. The method of claim 6, further comprising using the remote inventoried content delivery server to optimize the choice of which inventoried content to deliver across the mobile network.

10. The method of claim 6, further comprising monitoring the content inventory with the remote inventoried content delivery server.

11. The method of claim 10, wherein monitoring comprises counting each impression of inventoried content delivered across the mobile network.

12. The method of claim 11, further comprising receiving monitoring data from the remote inventoried content delivery server.

13. The method of claim 6, wherein the inventoried content comprises advertisements.

14. A system for providing inventoried content to a publisher in a mobile network, comprising:
an inventoried content delivery service;
an inventoried content provider, in communication with the inventoried content delivery service, the inventoried content provider configured to send inventoried content to the inventoried content delivery service; and
a remote inventoried content delivery server configured to receive inventoried content from the inventoried content delivery service, process the received inventoried content, and deliver the received inventoried content to a user across a mobile network.

15. The system of claim 14, further comprising an inventoried content server agent in communication with the remote inventoried content delivery server, the inventoried content server agent configured to monitor at least one interaction of a user of a mobile network with the inventoried content.

16. The system of claim 15, wherein the inventoried content server agent is further configured to monitor the inventory of the inventoried content.

17. The system of claim 15, wherein monitoring comprises counting each impression of inventoried content delivered across the mobile network.

18. The system of claim 15, wherein the inventoried content server agent is further configured to report monitored data to the inventoried content service provider.

19. The system of claim 15, wherein the inventoried content server agent is further configured to optimize the choice of which inventoried content to deliver across the mobile network.

20. The system of claim 14, wherein the inventoried content comprises advertisements.

21. A computer readable medium having embodied thereon a program, the program being executable by a processor for performing a method for providing inventoried content to a publisher in a mobile network, the method comprising:
installing a remote inventoried content delivery server in the collocation service area local to the publisher;
sending the inventoried content to the remote inventoried content delivery server;
receiving a request at the remote inventoried content delivery server for inventoried content from the publisher;
delivering the inventoried content from the remote inventoried content delivery server to a user across a mobile network.

22. The computer program recited in claim 21, wherein the method further comprises optimizing with the remote inventoried content delivery server the choice of which inventoried content to deliver across the mobile network.

23. The computer program recited in claim 21, wherein the method further comprises monitoring with the remote inventoried content delivery server the content inventory.

24. The computer program recited in claim 23, wherein the method further comprises receiving monitored data from the remote inventoried content delivery server.

25. The computer program recited in claim 21, wherein the inventoried content comprises advertisements.
